(19) United States
(12) Patent Application Publication
(10) Pub. No.: US 2023/0222119 A1
(43) Pub. Date: Jul. 13, 2023

(54) QUERY MODIFIED BASED ON DETECTED DEVICES

(71) Applicants: Maciej STOJKO, Krakow (PL); Justyna GWOZDZ, krakow (PL); Elizeusz MUSIAL, krakow (PL); Iwan BUGAJSKI, Grodek nad Dunajcem (PL); MOTOROLA SOLUTIONS, INC., CHICAGO, IL (US)

(72) Inventors: ELIZEUSZ MUSIAL, KRAKOW (PL); JUSTYNA GWOZDZ, KRAKOW (PL); IWAN BUGAJSKI, GRODEK NAD DUNAJCEM (PL); MACIEJ STOJKO, KRAKOW (PL)

(21) Appl. No.: 17/999,059

(22) PCT Filed: Jul. 29, 2020
(86) PCT No.: PCT/PL2020/000065

§ 371 Date: Nov. 17, 2022

(51) Int. Cl. G06F 16/242; G06F 16/2457; G10L 15/22

(52) U.S. Cl. CPC G06F 16/243; G06F 16/24575; G10L 15/22; G10L 2015/223; G10L 2015/225

(57) ABSTRACT

A method and apparatus for formulating a query by a digital assistant is provided herein. During operation a digital assistant will receive a query from a user. The query will have a type of device mentioned within the query. In response, the digital assistant will listen for any nearby device to announce itself. The query will then be modified by the digital assistant to include a device identification heard in the announcement. Results from the modified query will be provided to the user.

### BACKGROUND OF THE INVENTION

Tablets, laptops, phones (e.g., cellular or satellite), mobile (vehicular) or portable (personal) two-way radios, and other communication devices are now in common use by users, such as first responders (including firemen, police officers, and paramedics, among others), and provide such users and others with instant access to increasingly valuable additional information and resources such as vehicle histories, arrest records, outstanding warrants, health information, real-time traffic or other situational status information, and any other information that may aid the user in making a more informed determination of an action to take or how to resolve a situation, among other possibilities.

Many such communication devices further comprise, or provide access to, electronic digital assistants (or sometimes referenced as “virtual partners”) that may provide the user thereof with valuable information in an automated (e.g., without further user input) or semi-automated (e.g., with some further user input) fashion. The valuable information provided to the user may be based on explicit requests for such information posed by the user via an input (e.g., such as a parsed natural language input or an electronic touch interface manipulation associated with an explicit request) in which the electronic digital assistant may reactively provide such requested valuable information, or may be based on some other set of one or more context or triggers in which the electronic digital assistant may proactively provide such valuable information to the user absent any explicit request from the user.

As some existing examples, electronic digital assistants such as Siri provided by Apple, Inc.® and Google Now provided by Google, Inc.®, are software applications running on underlying electronic hardware that are capable of understanding natural language, and may complete electronic tasks in response to user voice inputs, among other additional or alternative types of inputs. These electronic digital assistants may perform such tasks as taking and storing voice dictation for future reference and retrieval, reading a received text message or an e-mail message aloud, generating a text message or e-mail message reply, looking up requested phone numbers and initiating a phone call to a requested contact, generating calendar appointments and providing appointment reminders, instructing users how to proceed with an assigned task, warning users of nearby dangers such as traffic accidents or environmental hazards, receiving a search query from a user and performing a database search, and providing many other types of information in a reactive or proactive manner.

Oftentimes public-safety officers are surrounded by many devices such as cameras, secure devices, mobile devices, PC/laptops and any electronic equipment in government buildings, cars, motorbikes or even streets. In many cases the officer may want to get information (i.e. during an investigation) about usage of some device or information about collected data by some device. Oftentimes, the officer may not even know a helpful device is present. Even if the officer knows a device is present, physical access to the device may be difficult to obtain (e.g. device is located on utility pole) or very inconvenient to obtain.

Considering the above, it would be very beneficial if a digital assistant could modify their search queries based on equipment on scene, even if the equipment is unknown to the officer or the officer has no access to the equipment's address. In doing so, the digital assistant will need to have a mechanism for determining the equipment on hand.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates an operational environment for the present invention.

FIG. 2 depicts an example communication system that incorporates a personal-area network and a digital assistant.

FIG. 3 is a more-detailed view of a personal-area network of FIG. 2.

FIG. 4 is a block diagram of a hub.

FIG. 5 is a block diagram of a smart device.

FIG. 6 is a flow chart showing operation of the hub of FIG. 4.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above-mentioned need, a method and apparatus for formulating a query by a digital assistant is provided herein. During operation a digital assistant will receive a query from a user. The query will have a type of device mentioned within the query. In response, the digital assistant will listen for any nearby device to announce itself. The query will then be modified by the digital assistant to include a device identification heard in the announcement. Results from the modified query will be provided to the user.

It should be noted that in order to perform the above, the devices (e.g. a camera) that announce their address are equipped with a microphone that can hear their device type being spoken as a query, and will respond with their own identifiers. As is evident, the officer need not be aware of how many devices are in the area. The officer could simply ask their digital assistant, “did a camera capture the accident?”. Any nearby camera that hears this question will output its own identifier (for example, via audio or visual signal) that can be detected by the digital assistant. Using such an audio or visual signal (not a radio-frequency (RF) signal) for the announcement makes the announcement easier to detect than since any RF transmission which would require at least minimal configuration or other pre association.

For example, in the simplest case, the camera could just output audio saying “I am camera 9001” in plain, spoken language, or modulated light. In some situations it may be better for the camera to respond in multi-tone sequences if long IDs are going to be provided (e.g., an internet address) since announcing an ID using multi-tone sequences will take less time then spoken language. No device pairing occurs between the digital assistant and the camera. If the officer knew the device ID beforehand, his query could simply be “Did camera 9001 see an accident?” However, this would then limit the query to only those devices that the officer is aware of and knows their identifiers. So in general, a generic query for a device type is converted to a query that lists specific device identifiers, without the person needing any information about what devices are around.

It should be noted that although the above description was given with respect to accessing a nearby camera, one of ordinary skill in the art will recognize that any device may be accessed in a similar manner. For example, devices such as, but not limited to a microphone, a video camera, a mechanical sensor, a chemical sensor, a weapon, a door, a motion detector, a gate counter/logger, a speed camera, an infra red camera, or any equipment (drone, any weapon, boat, bikes, anything that could be somehow considered as a part of some investigation) could be utilized in a similar manner. In other words, these devices may be equipped with a microphone that listens for a keyword. Once the keyword is heard, the device can be configured “announce” their device identification. It should be noted that devices may be configured to not announce their identifications if certain pre-conditions have not been met.

The keyword preferably comprises a generic device type. The generic device type utterance that triggers a device to respond with its address preferably comprises a name of a category of devices having common characteristics, and not a specific identification of a particular device. So for example, “camera”, “microphone”, “smoke detector”, . . . , etc. will all be considered generic device “types” as they do not refer to a particular camera, microphone, or smoke detector, but describe a category of devices having a common characteristic.

Although outside the scope of this invention, a device's response and keyword could be configured by device's owner, which could enable keeping some sensitive information within the response private. An owner of a device can select one of many responses (or not responding at all) base on some detected events or analytics.

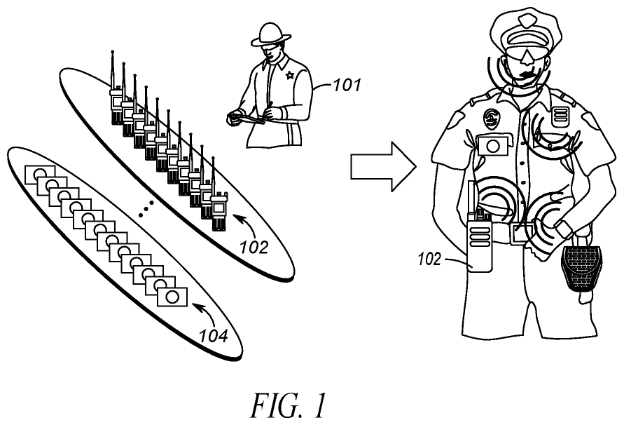

Turning now to the drawings, wherein like numerals designate like components, FIG. 1 illustrates an operational environment for the present invention. As shown, a public safety officer 101 will be equipped with certain connected devices that determine various physical and environmental conditions surrounding the public-safety officer. These conditions are generally reported back to a dispatch center so an appropriate action may be taken. For example, future police officers may have a sensor that determines when a gun is drawn. Upon detecting that an officer has drawn their gun, a notification may be sent back to the dispatch operator so that, for example, other officers in the area may be notified of the situation.

It is envisioned that the public-safety officer will have an array of shelved devices available to the officer at the beginning of a shift. The officer will select the devices off the shelf, and form a personal area network (PAN) with the devices that will accompany the officer on his shift. For example, the officer may pull a gun-draw sensor, a body-worn camera, a wireless microphone, a smart watch, a police radio, smart handcuffs, a man-down sensor, . . . , etc. All devices pulled by the officer will be configured (connected) to form a PAN by associating (pairing) with each other and communicating wirelessly among the devices. At least one device may be configured with a digital assistant. In a preferred embodiment, the PAN comprises more than two devices, so that many devices are connected via the PAN simultaneously.

A method called bonding is typically used for recognizing specific devices and thus enabling control over which devices are allowed to connect to each other when forming the PAN. Once bonded, devices then can establish a connection without user intervention. A bond is created through a process called “pairing”. The pairing process is typically triggered by a specific request by the user to create a bond from a user via a user interface on the device.

As shown in FIG. 1, public-safety officer 101 has an array of devices to use during the officer's shift. For example, the officer may pull one radio 102 and one camera 104 for use during their shift. Other devices may be pulled as well. As shown in FIG. 1, officer 101 will preferably wear the devices during a shift by attaching the devices to clothing. These devices will form a PAN throughout the officer's shift.

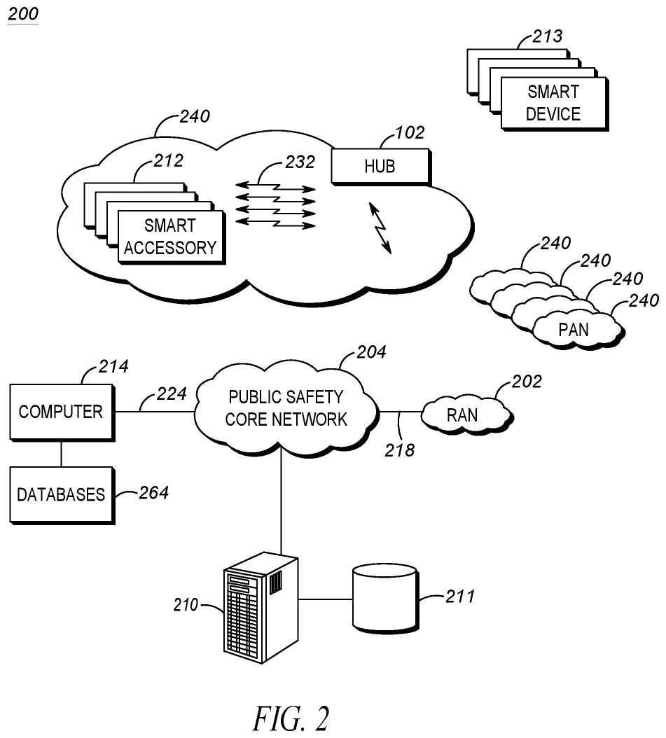

FIG. 2 depicts an example communication system 200 that incorporates PANs created as described above. System 200 includes one or more radio access networks (RANs) 202, a public-safety core network 204, hub (PAN primary device) 102, local devices (subordinate devices that serve as smart accessories/sensors) 212, computer 214, and communication links 218, 224, and 232. In a preferred embodiment of the present invention, hub 102 and devices 212 form PAN 240, with communication links 232 between devices 212 and hub 102 taking place utilizing a short-range communication system protocol such as a Bluetooth communication system protocol. Each officer will have an associated PAN 240. Thus, FIG. 2 illustrates multiple PANs 240 associated with multiple officers.

Additional smart devices 213 exist outside of the PAN. These devices 213 include sensors that are not connected to hub 102. Devices 213 are equipped with microphones (not shown in FIG. 2) and a natural-language processor. When any device 213 hears a human voice utter a generic device type associated with device 213, device 213 will announce its presence as an associated identification. For example, if a device 213 comprises a camera, then when the device hears the utterance “camera” or “cameras”, it will respond with an announcement. The response may be audible, sub-audible, visual, by sound sample (e.g. play a configured response). It may use any sound (such as human speech), any type of tone including ultrasounds or even light signal.

Regardless of the type of response, the response may include at least a device identification (ID). However, the device's address (IP, or network address) can be provided as well. This response provides hub 212 with the device type, ID, and/or network address. For example, hub 102 may receive “camera 123”, “camera 124” in response to a user uttering “camera” or may receive “smoke detector 421” in response to a user uttering “smoke detector”. Hub may also receive network address for the responding devices in response to the user uttering “camera” and/or “smoke detector”.

RAN 202 includes typical RAN elements such as base stations, base station controllers (BSCs), routers, switches, and the like, arranged, connected, and programmed to provide wireless service to user equipment (e.g., hub 102, and the like) in a manner known to those of skill in the relevant art. RAN 202 may implement a direct-mode, conventional, or trunked land mobile radio (LMR) standard or protocol such as European Telecommunications Standards Institute (ETSI) Digital Mobile Radio (DMR), a Project 25 (P25) standard defined by the Association of Public Safety Communications Officials International (APCO), Terrestrial Trunked Radio (TETRA), or other LMR radio protocols or standards. In other embodiments, RAN 202 may implement a Long Term Evolution (LTE), LTE-Advance, or 5G protocol including multimedia broadcast multicast services (MBMS) or single site point-to-multipoint (SC-PTM) over which an open mobile alliance (OMA) push to talk (PTT) over cellular (OMA-PoC), a voice over IP (VoIP), an LTE Direct or LTE Device to Device, or a PTT over IP (PoIP) application may be implemented. In still further embodiments, RAN 202 may implement a Wi-Fi protocol perhaps in accordance with an IEEE 802.11 standard (e.g., 802.11a, 802.11b, 802.11g) or a WiMAX protocol perhaps operating in accordance with an IEEE 802.16 standard.

Public-safety core network 204 may include one or more packet-switched networks and/or one or more circuit-switched networks, and in general provides one or more public-safety agencies with any necessary computing and communication needs, transmitting any necessary public-safety-related data and communications.

Hub 102 serves as a PAN primary device, and may be any suitable computing and communication device configured to engage in wireless communication with the RAN 202 over the air interface as is known to those in the relevant art. Moreover, one or more hubs 102 are further configured to engage in wired and/or wireless communication with one or more local device 212 via the communication link 232. Hub 102 will be configured to determine when to forward information received from PAN devices to, for example, a dispatch center or search engine. The information can be forwarded to the dispatch center or search engine via RANs 202 based on a combination of device 212 inputs. In one embodiment, all information received from sensors 212 will be forwarded to computer 214 via RAN 202. In another embodiment, hub 102 will filter the information sent, and only send high-priority information back to computer 214.

Hub 102 is also configured with a natural language processing (NLP) engine configured to determine the intent and/or content of the any over-the-air voice transmissions received by users and non-connected devices 213. The NLP engine may also analyze oral queries and/or statements received by any user and provide responses to the oral queries and/or take other actions in response to the oral statements.

It should be noted that any one or more of the communication links 218, 224, could include one or more wireless-communication links and/or one or more wired-communication links.

Devices 212 and hub 102 may comprise any device capable of forming a PAN. For example, devices 212 may comprise a gun-draw sensor, a body temperature sensor, an accelerometer, a heart-rate sensor, a breathing-rate sensor, a camera, a GPS receiver capable of determining a location of the user device, smart handcuffs, a clock, calendar, environmental sensors (e.g. a thermometer capable of determining an ambient temperature, humidity, presence of dispersed chemicals, radiation detector, etc.), an accelerometer, a biometric sensor (e.g., wristband), a barometer, speech recognition circuitry, a gunshot detector, . . . , etc. Some examples follow:

A sensor-enabled holster 212 may be provided that maintains and/or provides state information regarding a weapon or other item normally disposed within the user's sensor-enabled holster 212. The sensor-enabled holster 212 may detect a change in state (presence to absence) and/or an action (removal) relative to the weapon normally disposed within the sensor-enabled holster 212. The detected change in state and/or action may be reported to the portable radio 102 via its short-range transceiver. In some embodiments, the sensor-enabled holster may also detect whether the first responder's hand is resting on the weapon even if it has not yet been removed from the holster and provide such information to portable radio 102. Other possibilities exist as well.

A biometric sensor 212 (e.g., a biometric wristband) may be provided for tracking an activity of the user or a health status of the user 101, and may include one or more movement sensors (such as an accelerometer, magnetometer, and/or gyroscope) that may periodically or intermittently provide to the portable radio 102 indications of orientation, direction, steps, acceleration, and/or speed, and indications of health such as one or more of a captured heart rate, a captured breathing rate, and a captured body temperature of the user 101, perhaps accompanying other information.

An accelerometer 212 may be provided to measures acceleration. Single and multi-axis models are available to detect magnitude and direction of the acceleration as a vector quantity, and may be used to sense orientation, acceleration, vibration shock, and falling. A gyroscope is a device for measuring or maintaining orientation, based on the principles of conservation of angular momentum. One type of gyroscope, a microelectromechanical system (MEMS) based gyroscope, uses lithographically constructed versions of one or more of a tuning fork, a vibrating wheel, or resonant solid to measure orientation. Other types of gyroscopes could be used as well. A magnetometer is a device used to measure the strength and/or direction of the magnetic field in the vicinity of the device, and may be used to determine a direction in which a person or device is facing.

A heart rate sensor 212 may be provided and use electrical contacts with the skin to monitor an electrocardiography (EKG) signal of its wearer, or may use infrared light and imaging device to optically detect a pulse rate of its wearer, among other possibilities.

Computer 214 comprises, or is part of a computer-aided-dispatch center, manned by an operator providing necessary dispatch operations. For example, computer 214 typically comprises a graphical user interface that provides the dispatch operator necessary information about public-safety officers. As discussed above, much of this information originates from devices 212 providing information to hub 102, which forwards the information to RAN 202 and ultimately to computer 214. Computer 214 is configured to receive sensor data from sensors 212 and keep track of relevant information. For example, each user of the system may possess a hub with many associated devices forming a PAN. For each user of the system, computer 214 may track the user's current associated PAN devices (sensors 212) along with sensor data for that user. This information may be used to compile a summary for each user (e.g., equipment on hand for each user, along with state information for the equipment). The information is preferably stored in database 264.

Server 210 serves as a search engine and performs searching of database 211 as is commonly known in the art. Server 210 may comprise a commercial search server such as, but not limited to Google®, Yahoo®, Amazon®, . . . , etc. Alternatively, server may comprise a proprietary, internal server that performs searching on internal databases. Regardless of what type of search engine is provided, server 210 receives a modified query from hub 102, searches database 211, and provides an “answer” in response.

As shown server 210 is coupled to database 211. Database 211 comprises information to be searched. For example, database 211 may comprise web site addresses and content, crime history, department of motor vehicle (DMV) data, . . . , a video repository, an image repository, . . . , etc. It should be noted that although only one server 210 is shown coupled to database 211, there may exist many servers 210 providing searching capabilities, with each server 210 having its own database 211.

In one embodiment of the present invention, server 210 is shown as a separate entity from computer 214. However, in an alternate embodiment of the present invention, server 210 may lie internal to computer 214.

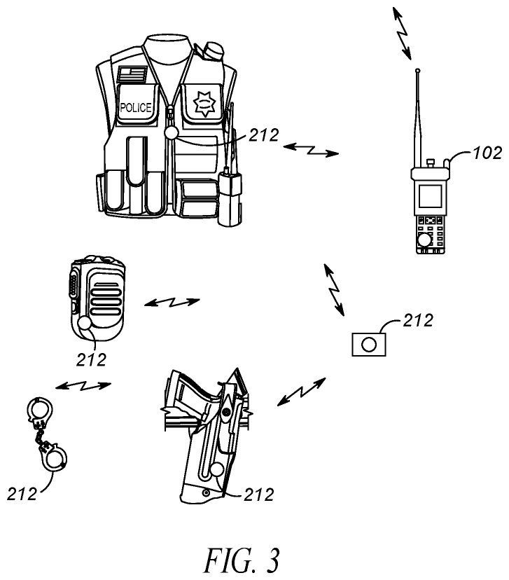

FIG. 3 depicts another view of a personal-area network 240 of FIG. 2. Device 213 is not a part of PAN 240, and thus, not shown in FIG. 3. Personal-area network comprises a very local-area network that has a range of, for example 10 feet. As shown in FIG. 3, various devices 212 are that attach to clothing utilized by a public-safety officer. In this particular example, a bio-sensor is located within a police vest, a voice detector is located within a police microphone, smart handcuffs 212 are usually located within a handcuff pouch (not shown), a gun-draw sensor is located within a holster, and a camera 212 is provided.

Devices 212 and hub 102 form a PAN 240. PAN 240 preferably comprises a Bluetooth PAN. Devices 212 and hub 102 are considered Bluetooth devices in that they operate using a Bluetooth, a short range wireless communications technology at the 2.4 GHz band, commercially available from the “Bluetooth special interest group”. Devices 212 and hub 102 are connected via Bluetooth technology in an ad hoc fashion forming a PAN. Hub 102 serves as a primary device while devices 212 serve as subordinate devices.

Hub 102 provides information to the officer, and/or forwards local status alert messages describing each sensor state/trigger event over a wide-area network (e.g., RAN/Core Network) to computer 214. In alternate embodiments of the present invention, hub 102 may forward the local status alerts/updates for each sensor to mobile and non-mobile peers (shift supervisor, peers in the field, etc), or to the public via social media. RAN core network preferably comprises a network that utilizes a public-safety over-the-air protocol. Thus, hub 102 receives sensor information via a first network (e.g., Bluetooth PAN network), and forwards the information to computer 214 via a second network (e.g., a public safety wide area network (WAN)). When the virtual partner is located within computer 214, any request to the virtual partner will be made via the second network. In addition, any communication from the virtual partner to computer 214 will take place using the second network.

As described above, hub 102 is also equipped with a digital assistant that is constantly listening for human voice and device announcements. Additionally, as mentioned above, it would be beneficial if a digital assistant could modify their search queries based on equipment on scene, even if the equipment is unknown to the officer. In doing so, the digital assistant will need to have a mechanism for determining the equipment on hand. Thus, during operation a digital assistant within hub 102 will receive a query from a user, the query will have a generic type of device 213 mentioned within the query. In response, the digital assistant will listen for device 213 to announce itself. The query will then be modified by the digital assistant to include the device identification. Results from the modified query will be provided to the user.

It should be noted that the “type of device” mentioned in the query does not contain the actual identification of device 213, but is instead a generic descriptor for device 213. For example, the device name for device 213 may comprise a media access address (MAC address), or a specific camera identification (e.g., camera 21203858). However, the generic “type of device” may simply comprise “camera”, without mentioning the specific camera name or address.

Hub 102 will then modify a query received by the user to include the information received in the announcement from device 213. For example, if a user asks the digital assistant, “were any cameras recording 1 hour ago?”, and the digital assistant “hears” nearby devices announce “camera 45”, “camera 42”, “camera 103”, then the digital assistant will modify the query to include the information mentioned in the announcements. For example, the digital assistant may modify the query to state, “where cameras 45, 42, or 103 recording an hour ago?”. Alternatively, multiple queries may be sent based on each response heard from devices 213. For example, “did camera 45 record video an hour ago?”, “did camera 42 record video an hour ago?”, and “did camera 103 record video an hour ago?”.

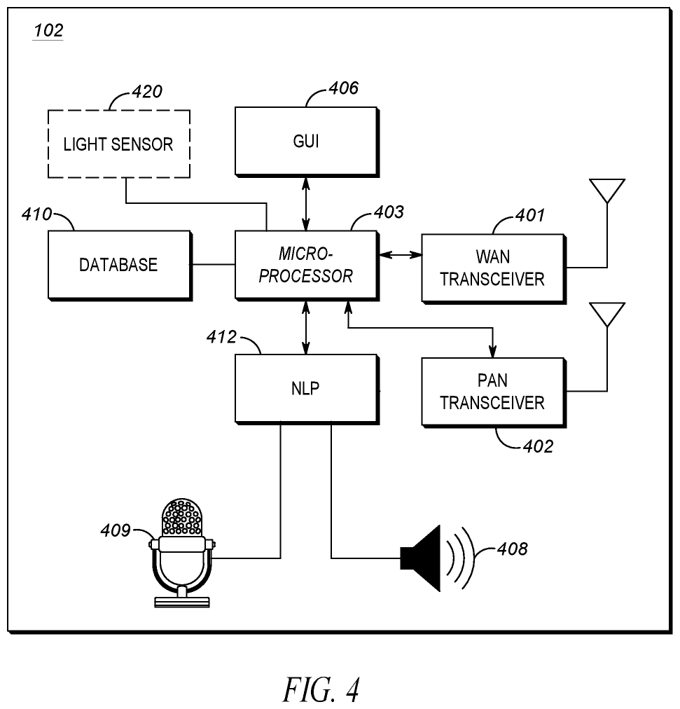

With the above in mind, FIG. 4 sets forth a block diagram hub 102 that utilizes a digital assistant to determine what devices/equipment is present and modify a query accordingly. As mentioned, in one embodiment, the components shown in FIG. 4 are embodied within hub 102, however in alternate embodiments these components may be embodied within the public-safety core network 204, or more computing devices in a cloud compute cluster (not shown), or some other communication device not illustrated in FIG. 2, and/or may be a distributed communication device across two or more entities.

FIG. 4 shows those components (not all necessary) for device 102 to determine what non-PAN equipment is present and to modify a query accordingly. For ease of illustration some components have been left out of FIG. 4. As shown, hub 102 includes a wide-area-network (WAN) transceiver 401 (e.g., a transceiver that utilizes a public-safety communication-system protocol), PAN transceiver 402 (e.g., a short-range transceiver), Graphical User Interface (GUI) 406, database 410, logic circuitry 403, speaker 408, microphone 409, and NLP 412. In other implementations, hub 102 may include more, fewer, or different components. For example, if digital-assistant functionality is being provided by dispatch center 214, then database 410 and NLP 412 may be absent from hub 102.

WAN transceiver 401 may comprise well known long-range transceivers that utilize any number of network system protocols. (As one of ordinary skill in the art will recognize, a transceiver comprises both a transmitter and a receiver for transmitting and receiving data). For example, WAN transceiver 401 may be configured to utilize a next-generation cellular communications protocol operated by a cellular service provider, or any public-safety protocol such as an APCO 25 network or the FirstNet broadband network. WAN transceiver 401 is utilized for sending and receiving data. For example, a query may be sent to server 210 via transceiver 401, or sensor 212 data may be sent to dispatch center 214 via transceiver 410.

PAN transceiver 402 may be well known short-range (e.g., 30 feet of range) transceivers that utilize any number of network system protocols. For example, PAN transceiver 402 may be configured to utilize Bluetooth communication system protocol for a body-area network, or a private 802.11 network. PAN transceiver 402 is utilized for hub 102 to communicate with sensors 212.

GUI 406 comprises provides a way of displaying information and receiving an input from a user. For example, GUI 406 may provide a way of conveying (e.g., displaying) information to a user regarding that status of devices 212, or any search results obtained by logic circuitry 403/NLP 412 serving as a digital assistant.

Microphone 409 provides a mechanism for receiving human voice and providing it to the virtual partner (e.g., logic circuitry 403/NLP 412). Speaker 408 outputs audible information generated by the digital assistant (e.g., a voice). Microphone 409 is also utilized to “hear” announcements from non-connected devices 213 (i.e., devices not associated with hub 102).

Logic circuitry 403 comprises a digital signal processor (DSP), general purpose microprocessor, a programmable logic device, or application specific integrated circuit (ASIC) and is configured along with NLP 412 to provide digital assistant functionality and modify a search query as described above. More particularly, search queries are modified to include identifications, names and/or addresses of specific devices heard in announcements.

Database 410 is provided. Database 410 comprises standard memory (such as RAM, ROM, . . . , etc) and serves to store PAN member names (identifications) and their statuses. So, for example, database 410 may comprise a list of PAN members (long gun, bullet-proof vest, gun-draw sensor, . . . , etc.) that formed a PAN with hub 102. Database 410 also store status information for each sensor (e.g., long gun in use, bullet-proof vest being worn, dun-draw sensor indicating a gun is holstered, . . . , etc.). Database 110 may also comprise utterances that will be used by any digital assistant in communicating with a user (e.g., processor 403/NLP 412).

NLP 412 may be a well known circuitry/software to analyze, understand, and derive meaning from human language in a smart and useful way. By utilizing NLP 412, automatic summarization, translation, named entity recognition, relationship extraction, sentiment analysis, speech recognition, and topic segmentation can take place.

Regardless of whether or not digital-assistant functionality is located within dispatch center 214, or whether digital-assistant functionality is located within hub 102, the digital assistant will modify queries based on non-PAN devices detected by hub 102 via the “announcements” made by the non-PAN devices.

Optional light sensor 420 may be provided when communications between devices 213 and hub 102 takes place via modulated light. Optional light sensor 420 preferably comprises a photoconductor (photoresistor), photovoltaic device (photocell), phototransistor, or photodiode that is configured to detect the modulated light emitted from any device 213.

Considering the above, a user may be interested in specific devices which are in the user's vicinity (e.g., street camera, computer, gate counter, or other sensors). As mentioned, these devices are outside the PAN. PAN devices are already known by hub 102 as well as the user, however, non-PAN may not be known to hub 102. Since non-PAN devices will be equipped to detect keywords (which comprise a type of device), when a non-PAN device hears the keywords, they announce their presence and their identification to hub 102. Hub 102 will then modify any received user query to include the identification announced to hub 102.

With the above in mind, hub 102 comprises an apparatus for modifying an audible user query, hub 102 comprises microphone 409 receiving the audible user query from a user which has a generic term for a type of device. Circuitry 420/409 is provided for receiving an announcement from a specific device in response to the specific device hearing the audible user query from the user. Finally, logic circuitry 403 is provided for modifying the audible user query with information received in the announcement as described above.

As discussed, the circuitry for receiving the announcement comprises light sensor 420 when modulated light is being used for communication between the specific device and hub 102, or comprises microphone 409 when sound is being used for communication between the specific device and hub 102.

As discussed above, the generic term for the type of device triggers the announcement from the specific device.

Additionally, transmitter (part of transceiver 401) is provided and configured to transmit the modified user query to a search engine. More specifically, the modified user query is converted to a format suitable for over-the-air transmission. This may comprise an appropriately-modulated text string suitable for transmission over RAN 202 to computer 214 or server 210.

Receiver (part of transceiver 401) is provided and configured to receive data (e.g., search results) from a search engine in response to the modified user query. In this particular embodiment, server 210 or computer 214 may be thought of as search engines as they receive any modified user query and perform an appropriate database search using the modified user query. Search results from the database search are then transmitted to hub 102 via RAN 202.

Graphical user interface 406 is provided, and configured to provide the data (search results) from the search engine to the user. Alternatively, speaker 408 may provide an audible representation of search results received from any search engine.

As discussed above, the announcement received from any device may comprise an address for the specific device. When this is the case, logic circuitry 403 is configured to modify the user query by modifying the user query to include the address for the specific device.

In a similar manner, the announcement received from any device may comprise an identification of the specific device. When this is the case, logic circuitry 403 is configured to modify the user query by modifying the user query to include the identification for the specific device.

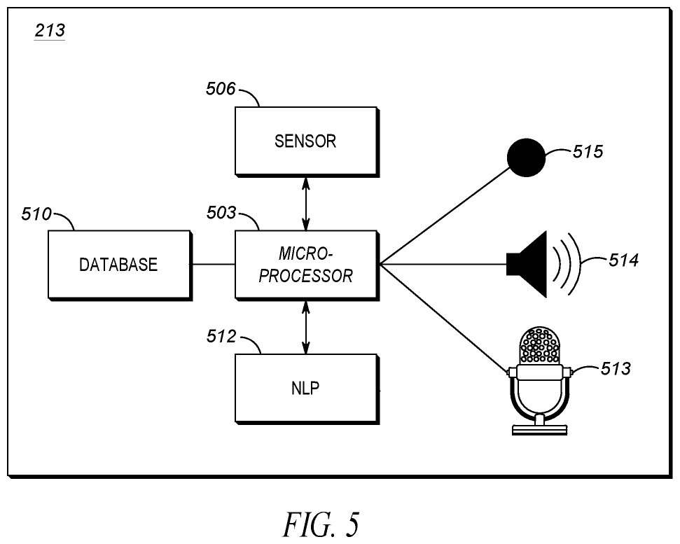

FIG. 5 is a block diagram of device 213. As shown, device 213 comprises sensor 506, database 510, logic circuitry 503, NLP 512, microphone 513, optional diode 515, and speaker 514. The components shown in FIG. 5 are similar to those described above with respect to FIG. 4.

Sensor 506 preferably comprises an environmental sensor which records and stores data about the surrounding environment. For example, sensor 506 may comprise an image detector that records and stores video in database 510. During operation, microphone 513 will hear a generic device name uttered by a user. This is passed to logic circuitry 503/NLP 512 which recognizes the generic name as a trigger to provide information about the device 213. In response, logic circuitry instructs speaker 514 to provide an “announcement” as described above. In an alternate embodiment of the present invention, diode 515 may be used to provide the “announcement” via modulated light. Thus the “announcement” is preferably made audibly by speaker 514, however, in alternate embodiments of the present invention, speaker 514 may be replaced with a diode 515 for communication via modulated light. In this case, the announcement will be made by modulating light from diode 515.

In a first embodiment, the announcement provided to hub 102 comprises at least a device identification. In alternate embodiments of the present invention the address of the device may be provided in the announcement as well.

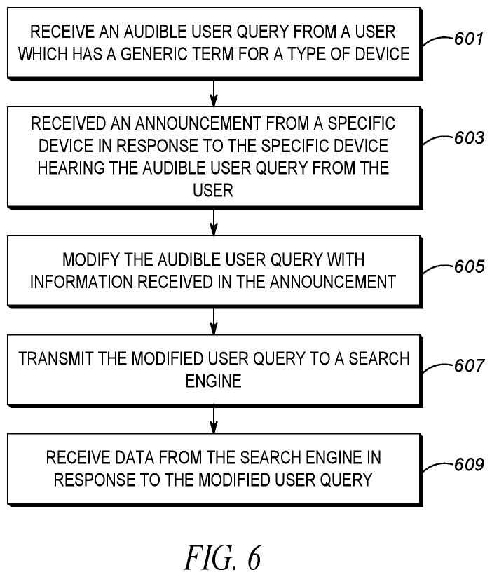

FIG. 6 is a flow chart showing operation of hub 102. The logic flow begins at step 601 where microphone 409 receives an audible user query from a user which has a generic term for a type of device. At step 603 an announcement is received from a specific device in response to the specific device hearing the audible user query from the user. As discussed, this announcement may be received via microphone 409 or alternatively, via light sensor 420.

The logic flow continues to step 605 where logic circuitry receives the announcement and modifies the audible user query with information received in the announcement.

As discussed above, the reception by the specific device, of the generic term for the type of device, triggers the announcement from the specific device. Additionally, the above logic flow may comprise the additional steps of transmitting the modified user query to a search engine (optional step 607) and receiving data from the search engine in response to the modified user query (optional step 609).

Additionally, as discussed above, data from the search engine may be provided to the user via a user interface.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for modifying an audible user query, the method comprising the steps of:
receiving the audible user query from a user which has a generic term for a type of device;
receiving an announcement from a specific device in response to the specific device hearing the audible user query from the user; and
modifying the audible user query with information received in the announcement.

2. The method of claim 1 wherein the generic term for the type of device triggers the announcement from the specific device.

3. The method of claim 1 further comprising the steps of:
transmitting the modified user query to a search engine; and
receiving data from the search engine in response to the modified user query.

4. The method of claim 3 further comprising the step of:
providing the data from the search engine to the user via a user interface.

5. The method of claim 1 wherein the announcement comprises an address for the specific device, and the step of modifying the user query comprises the step of modifying the user query to include the address for the specific device.

6. The method of claim 1 wherein the announcement comprises an identification of the specific device, and the step of modifying the user query comprises the step of modifying the user query to include the identification for the specific device.

7. A method for modifying an audible user query, the method comprising the steps of:
receiving the audible user query from a user which has a generic term for a type of device;
receiving an announcement from a specific device in response to the specific device hearing the audible user query from the user;
modifying the audible user query with information received in the announcement;
transmitting the modified user query to a search engine;
receiving data from the search engine in response to the modified user query;
providing the data from the search engine to the user via a user interface;
wherein the generic term for the type of device triggers the announcement from the specific device; and
wherein the announcement comprises an address or an identification for the specific device, and the step of modifying the user query comprises the step of modifying the user query to include the address or identification for the specific device.

8. An apparatus for modifying an audible user query, the apparatus comprising:
a microphone receiving the audible user query from a user which has a generic term for a type of device;
circuitry receiving an announcement from a specific device in response to the specific device hearing the audible user query from the user; and
logic circuitry modifying the audible user query with information received in the announcement.

9. The apparatus of claim 8 wherein the circuitry comprises a light sensor or the microphone.

10. The apparatus of claim 8 wherein the generic term for the type of device triggers the announcement from the specific device.

11. The apparatus of claim 8 further comprising:
a transmitter configured to transmit the modified user query to a search engine; and
a receiver configured to receive data from the search engine in response to the modified user query.

12. The apparatus of claim 11 further comprising:
a graphical user interface configured to provide the data from the search engine to the user.

13. The apparatus of claim 8 wherein the announcement comprises an address for the specific device, and the logic circuitry is configured to modify the user query by modifying the user query to include the address for the specific device.

14. The apparatus of claim 8 wherein the announcement comprises an identification of the specific device, and the logic circuitry modifies the user query by modifying the user query to include the identification for the specific device.
